(19) United States
(12) Patent Application Publication
(10) Pub. No.: US 2014/0293199 A1
(43) Pub. Date: Oct. 2, 2014

(54) LIQUID CRYSTAL DISPLAY AND METHOD OF MANUFACTURING THE SAME

(71) Applicant: Samsung Display Co., Ltd., Yongin-city (KR)

(72) Inventors: Tanaka SAKAE, Suwon-si (KR); Kichul Shin, Seongnam-si (KR); Cheol Shin, Hwaseong-si (KR); Yoshimoto Hiroshi, Seoul (KR)

(73) Assignee: Samsung Display Co., Ltd., Yongin-city (KR)

(21) Appl. No.: 13/962,600

(22) Filed: Aug. 8, 2013

(30) Foreign Application Priority Data
Mar. 27, 2013 (KR) 10-2013-0032909

(51) Int. Cl. G02F 1/1362

(52) U.S. Cl. CPC G02F 1/136286
USPC 349/106; 438/30

(57) ABSTRACT

A liquid crystal display includes a first substrate, a second substrate, and a liquid crystal layer disposed therebetween. The first substrate includes: a first base substrate, a gate line disposed on the first base substrate, a first electrode disposed on the first base substrate, the first electrode configured to receive a driving voltage, a data line crossing the gate line, a bump disposed on and formed along the data line, and a second electrode including a shielding electrode portion disposed on the bump and a common electrode portion disposed in association with a center portion of the first electrode. The second substrate includes: a second base substrate facing the first base substrate, and color filters disposed on the second base substrate. Adjacent color filters partially overlap one another in a region comprising the bump to provide a protrusion portion protruded from the second base substrate towards the first base substrate.

### CROSS-REFERENCE TO RELATED APPLICATION

This application claims priority from and the benefit of Korean Patent Application No. 10-2013-0032909, filed on Mar. 27, 2013, which is incorporated by reference for all purposes as if set forth herein.

### BACKGROUND

1. Field

Exemplary embodiments relate to display technology, and more particularly, to a lateral electric field driven liquid crystal display and a method of manufacturing the same.

2. Discussion

Conventional liquid crystal displays are flat panel display devices configured to is display an image using a controllable liquid crystal layer. Typically, liquid crystal displays are classified into two general categories based on a driving method thereof, such as lateral electric field mode liquid crystal displays and vertical electric field mode liquid crystal displays. Lateral electric field mode liquid crystal displays are configured to form a lateral electric field between, for example, two electrodes, which drive a liquid crystal layer. Vertical electric field mode liquid crystal displays are configured to form a vertical electric field between, for instance, two electrodes, which drive a liquid crystal layer.

In a vertical electric field driven liquid crystal display, the two electrodes are typically disposed on two respective substrates included in a liquid crystal display panel. In a lateral electric field driven liquid crystal display, the two electrodes are usually disposed on one of the two substrates. It is noted that, in association with lateral electric field driven liquid crystal displays, liquid crystal molecules of the liquid crystal layer disposed adjacent to the substrate including the two electrodes are more easily controlled than liquid crystal molecules of the liquid crystal layer disposed adjacent to the other substrate not including the two electrodes. In this manner, light transmittance may be reduced, and a driving voltage used to control the liquid crystal molecules is typically higher than a vertical electric field driven liquid crystal display.

The above information disclosed in this Background section is only for enhancement of understanding of the background of the invention, and, therefore, it may contain information that does not form the prior art that is already known in this country to a person of ordinary skill in the art.

### SUMMARY

Exemplary embodiments provide liquid crystal displays configured to improve light transmittance and reduce driving voltage.

Exemplary embodiments provide a method of manufacturing the liquid crystal displays.

Additional aspects will be set forth in the detailed description which follows and, in part, will be apparent from the disclosure, or may be learned by practice of the invention.

According to exemplary embodiments, a liquid crystal display includes: a first substrate, a second substrate, and a liquid crystal layer disposed between the first substrate and the second substrate. The first substrate includes: a first base substrate, a gate line disposed on the first base substrate, a first electrode disposed on the first base substrate, the first electrode configured to receive a driving voltage, a data line crossing the gate line, a bump disposed on and formed along the data line, and a second electrode including: a shielding electrode portion disposed on the bump, and a common electrode portion disposed in association with a center portion of the first electrode, the second electrode configured to receive a reference voltage. The second substrate includes: a second base substrate facing the first base substrate, and color filters disposed on the second base substrate. Adjacent color filters partially overlap one another in a region comprising the bump to provide a protrusion portion protruded from the second base substrate towards the first base substrate.

According to exemplary embodiments, a method of manufacturing a liquid crystal display includes: forming a first substrate, forming a second substrate, and forming a liquid crystal layer between the first substrate and the second substrate. Formation of the first substrate includes: forming a gate line and a first electrode on a first base substrate, the first electrode being configured to receive a driving voltage, forming a gate insulating layer on the gate line and is the first electrode, forming a data line on the gate insulating layer to cross the gate line, forming a protective layer on the data line, forming a bump on the protective layer along the data line, and forming a second electrode including a shielding electrode portion disposed on the bump and a common electrode portion disposed in association with a center portion of the first electrode, the second electrode being configured to receive a reference voltage. Formation of the second substrate includes: forming color filters on a second base substrate facing the first base substrate. Adjacent color filters are formed to partially overlap one another in a region including the bump to provide a protrusion portion protruded from the second base substrate towards the first base substrate.

According to exemplary embodiments, the bump is formed along the data line and the shielding electrode portion is formed on the bump. In this manner, the liquid crystal molecules may be more easily controlled and the transmittance may be improved. To this end, the power consumption of the liquid crystal display may be reduced. In addition, since the cell gap may be determined based on the protrusion portion disposed on the second substrate, which is provided by the color pixel, and the bump on the first substrate, a separate spacer, which is typically utilized to maintain the cell gap, may be omitted. To this end, a process of forming the spacer may be omitted when the liquid crystal display is being manufactured. In this manner, the manufacturing process may not only be simplified, but the cost thereof may be reduced.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a liquid crystal display, according to exemplary embodiments.

FIG. 2 is an equivalent circuit diagram of a pixel of the liquid crystal display of FIG. 1, according to exemplary embodiments.

FIG. 3 is a plan view of a liquid crystal display panel, according to exemplary embodiments.

FIG. 4 is a cross-sectional view of the liquid crystal display panel of FIG. 3 taken along sectional line I-I′, according to exemplary embodiments.

FIG. 5 is a cross-sectional view of the liquid crystal display panel of FIG. 3 taken along sectional line II-II′, according to exemplary embodiments.

FIG. 6 is a graph comparing transmittance with driving voltage, according to exemplary embodiments.

FIG. 7 is a plan view of a second substrate of a liquid crystal display, according to exemplary embodiments.

FIG. 8 is a cross-sectional view of the liquid crystal display of FIG. 7 taken along sectional line III-III′, according to exemplary embodiments.

FIG. 9 is a cross-sectional view of a first substrate, according to exemplary embodiments.

FIG. 10 is a plan view of a liquid crystal display panel, according to exemplary is embodiments.

FIG. 11 is a cross-sectional view of the liquid crystal display panel of FIG. 10 taken along sectional line IV-IV′, according to exemplary embodiments.

FIG. 12 is a graph comparing transmittance with driving voltage, according to exemplary embodiments.

FIG. 13 is a cross-sectional view of the liquid crystal display of FIG. 10 taken along sectional line V-V′, according to exemplary embodiments.

FIG. 14 is a plan view of a first substrate, according to exemplary embodiments.

FIG. 15 is a cross-sectional view of the first substrate of FIG. 14 taken along sectional line VI-VI′, according to exemplary embodiments.

FIG. 16 is a cross-sectional view of a first substrate, according to exemplary embodiments.

FIGS. 17A-17E are respective plan views of the first substrate of FIG. 3 at various stages of manufacture, according to exemplary embodiments.

FIG. 18 is a plan view of an alignment direction of an optical alignment layer, according to exemplary embodiments.

FIG. 19 is a plan view of an alignment direction of an optical alignment layer, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced is without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” and/or the like, may be used herein for descriptive purposes, and thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and as such, the spatially relative descriptors used herein interpreted accordingly.

The terminology used herein is for the purpose of describing particular embodiments and is not intended to be limiting. As used herein, the singular forms “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

While exemplary embodiments are described in association with liquid crystal display devices, it is contemplated that exemplary embodiments may be utilized in association with other or equivalent display devices, such as various self-emissive and/or non-self-emissive display technologies. For instance, self-emissive display devices may include organic light emitting displays (OLED), plasma display panels (PDP), etc., whereas non-self-emissive display devices may include electrophoretic displays (EPD), electrowetting displays (EWD), etc.

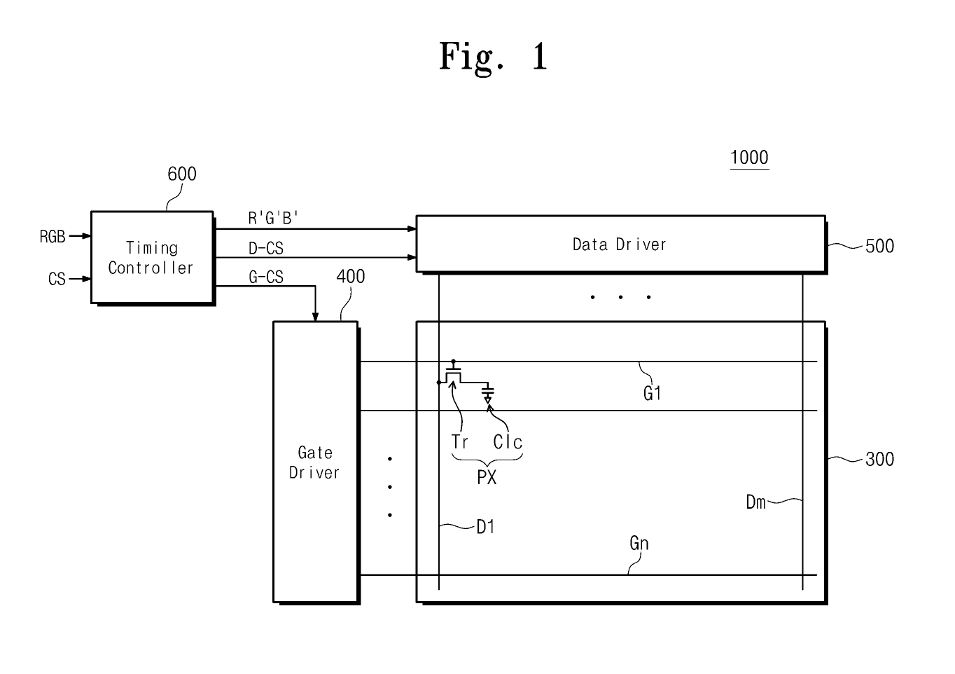

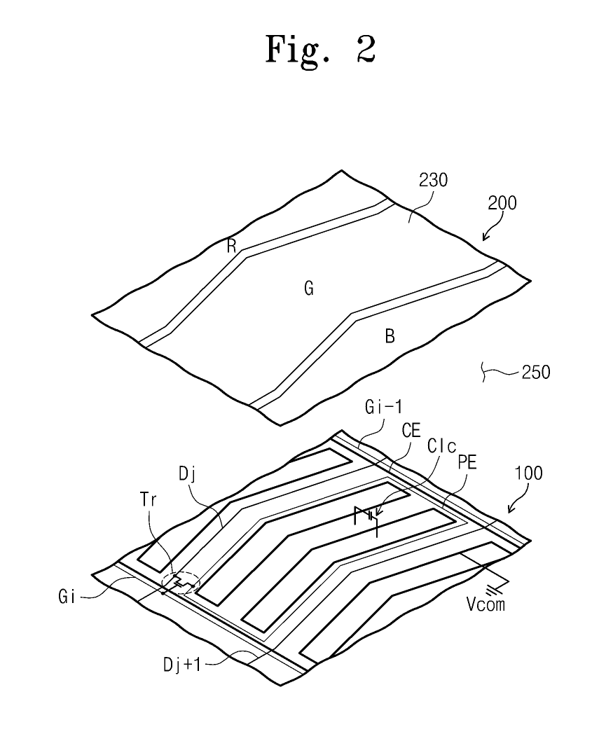

FIG. 1 is a block diagram of a liquid crystal display, according to exemplary embodiments. FIG. 2 is an equivalent circuit diagram of a pixel of the liquid crystal display of FIG. 1.

Referring to FIG. 1, a liquid crystal display 1000 includes an image display part 300 configured to display an image, gate and data drivers 400 and 500 configured to drive the image display part 300, and a timing controller 600 configured to control the gate and data drivers 400 and 500. While specific reference will be made to this particular implementation, it is also contemplated that the liquid crystal display 1000 may embody many forms and include multiple and/or alternative components. For example, it is contemplated that the components of the liquid crystal display 1000 may be combined, located in separate structures, and/or separate locations.

According to exemplary embodiments, the image display part 300 includes a plurality of gate lines G1 to Gn, a plurality of data lines D1 to Dm, and a plurality of pixels PX. As shown in FIG. 2, the image display part 300 includes a first substrate 100, a second substrate 200 facing the first substrate 100, and a liquid crystal layer 250 disposed between the first substrate 100 and the second substrate 200.

The gate lines G1 to Gn and the data lines D1 to Dm are disposed on the first is substrate 100. The gate lines G1 to Gn extend in a first (e.g., row or horizontal) direction and are arranged in a second (e.g., column or vertical) direction. In this manner, the gates lines G1 to Gn are parallel or substantially parallel to each other. The data lines D1 to Dm extend in the second direction and are arranged in the first direction. In this manner, the data lines D1 to Dn are parallel or substantially parallel to each other.

According to exemplary embodiments, each pixel PX, e.g., a pixel connected to an i-th (where “i” is an integer equal to or greater than 1) gate line G1 and a j-th (where “j” is an integer equal to or greater than 1) data line Dj, includes a switching element (e.g., thin film transistor Tr) and a voltage storage device, e.g., liquid crystal capacitor Clc. The thin film transistor Tr includes a gate electrode connected to the i-th gate line G1, a source electrode connected to the j-th data line Dj, and a drain electrode connected to the liquid crystal capacitor Clc. To this end, the liquid crystal capacitor Clc includes a first electrode PE and a second electrode CE, which are disposed on the first substrate 100. In this manner, the first and second electrodes PE and CE are configured as two terminals of the liquid crystal capacitor Clc, and the liquid crystal layer 250 is configured as a dielectric substance of the liquid crystal capacitor Clc. The first electrode PE is electrically connected to, for instance, the drain electrode of the thin film transistor Tr, and, thereby, configured to receive a data voltage from the j-th data line Dj. The second electrode CE is configured to receive a reference voltage Vcom.

In exemplary embodiments, each pixel PX includes a color filter 230 disposed on the second substrate 200 to correspond to the first electrode PE. The color filter 230 is configured to facilitate the display one or more colors, such as one or more primary colors.

Adverting to FIG. 1, the timing controller 600 is configured to receive image signals RGB and control signals CS from a source associated with the liquid crystal display 1000, such as a source outside of (or otherwise external to) the liquid crystal display 1000. The timing controller 600 is configured to convert a data format of the image signals RGB into a data format suitable for interfacing with the data driver 500. To this end, the timing controller 600 is configured to provide the converted image signals R′G′B′ to the data driver 500. In addition, the timing controller 600 is configured to generate one or more data control signals D-CS, such as an output start signal, a horizontal start signal, etc., and one or more gate control signals G-CS, such as a vertical start signal, a vertical clock signal, a vertical clock bar signal, etc. The data control signal D-CS is applied to the data driver 500 and the gate control signal G-CS is applied to the gate driver 400.

According to exemplary embodiments, the gate driver 400 is configured to output (e.g., sequentially output) gate signals to the gates lines G1 to Gn in response to the gate control signal G-CS received from, for example, the timing controller 600. In this manner, the pixels PX may be scanned (e.g., sequentially scanned) by one or more rows based on the gate signals. The data driver 500 is configured to convert the image signals R′G′B′ into one or more data voltages in response to the data control signal D-CS received from, for instance, the timing controller 600. The data voltages may be applied to the image display part 300 in association with one or more of the pixels PX. In this manner, each pixel PX may be “turned on” in response to a corresponding gate signal of the gate signals, and a “turned-on” pixel PX may be configured to receive a corresponding data voltage of the data voltages from the data driver 500 to facilitate the display of a desired image.

According to exemplary embodiments, the timing controller 600, the gate driver 400, and/or the data driver 500 may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

In exemplary embodiments, the processes described herein may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. In this manner, the liquid crystal display device 1000 may include or otherwise be associated with one or more memories (not shown) including code (e.g., instructions) configured to cause the liquid crystal display device 1000 to perform one or more of the features/functions/processes described herein.

The memories may be any medium that participates in providing code/instructions to the one or more software, hardware, and/or firmware for execution. Such memories may take many forms, including but not limited to non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

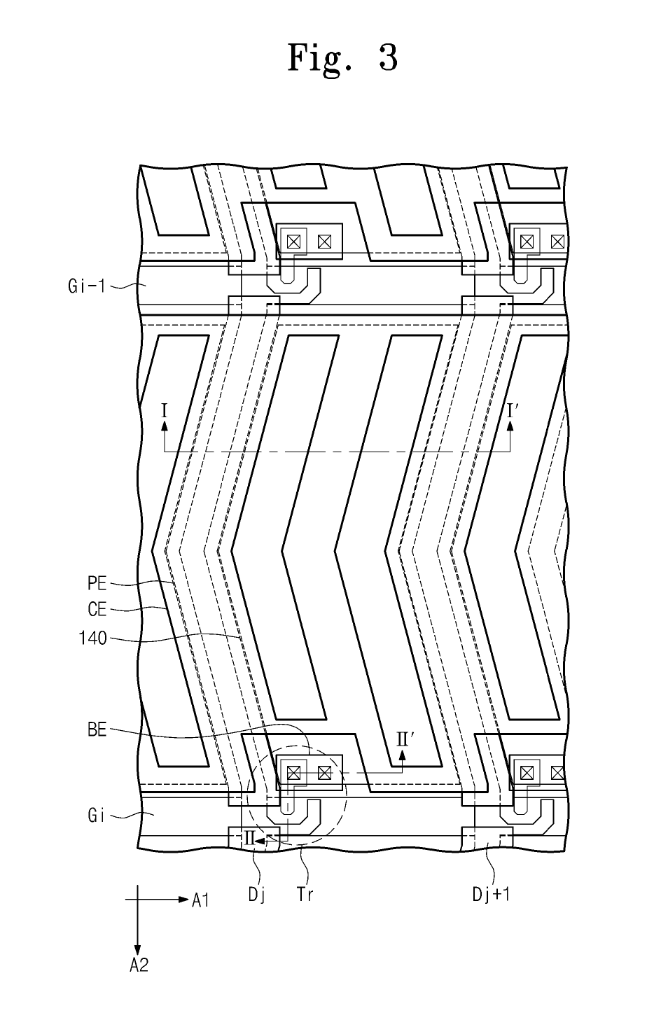

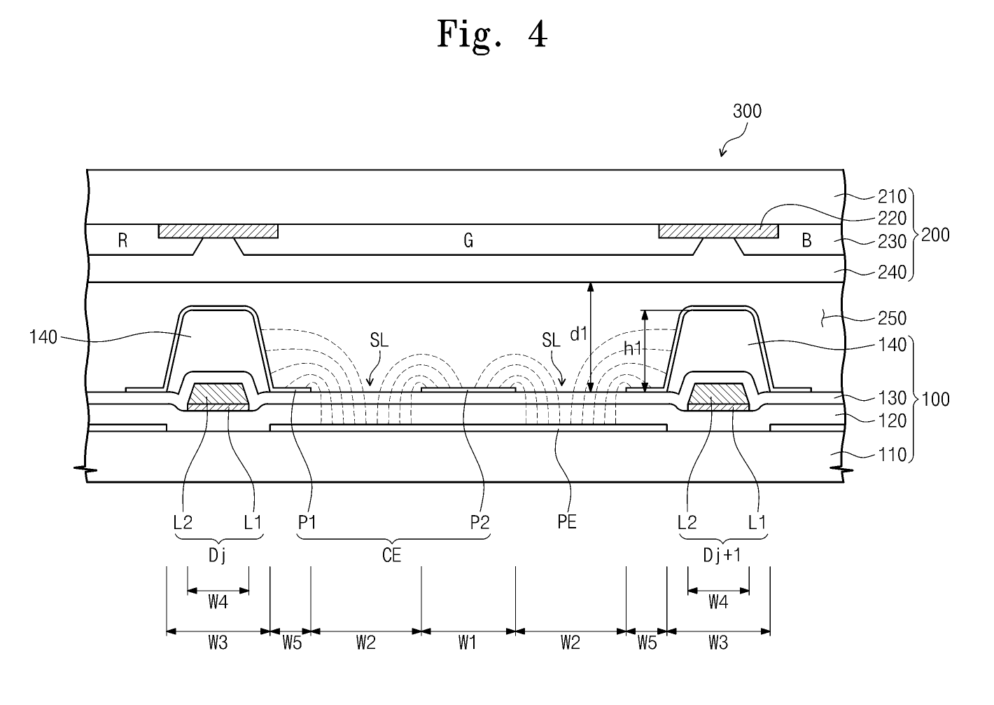

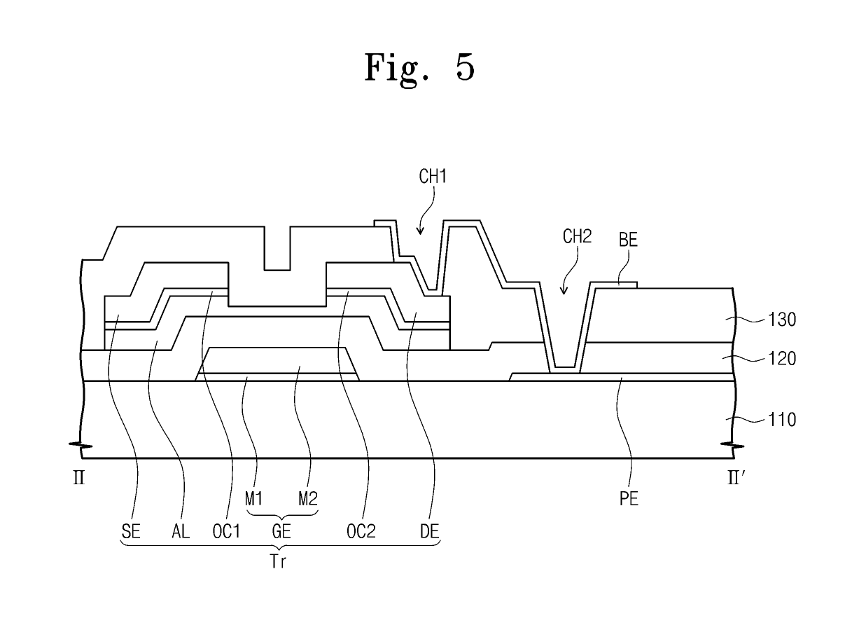

FIG. 3 is a plan view of a liquid crystal display panel, according to exemplary embodiments. FIG. 4 is a cross-sectional view of the liquid crystal display panel of FIG. 3 taken is along sectional line I-I′. FIG. 5 is a cross-sectional view of the liquid crystal display panel of FIG. 3 taken along sectional line II-II′.

Referring to FIGS. 3 to 5, the liquid crystal display panel may be included as part of the image display part 300. To this end, the liquid crystal display panel may include the first substrate 100, the second substrate 200 facing the first substrate 100, and the liquid crystal layer 250 disposed between the first substrate 100 and the second substrate 200.

According to exemplary embodiments, the first substrate 100 includes a first insulating substrate 110 formed of any suitable material, such as, for example, transparent glass, plastic, etc. As seen in FIG. 4, the first substrate 100 also includes first and second gate lines Gi−1 and G1, and first and second data lines Dj and Dj+1 disposed on the first insulating substrate 110. While not illustrated, the first substrate 100 includes the other gate lines G1 to Gn and the other data lines D1 to Dn. As such, while exemplary embodiments may be described in association with the respective first and second gates lines Gi−1 and G1, and the first and second data lines Dj and Dj+1, it is noted that exemplary embodiments are applicable to the other ones of the gate lines G1 to Gn and the other data lines D1 to Dn.

In exemplary embodiments, the first and second gate lines Gi−1 and G1 extend in a first direction A1 and are spaced apart from each other in a second direction A2 perpendicular (or substantially perpendicular) to the first direction A1. The first and second data lines D1 and Dj+1 extend in the second direction A2 and are spaced apart from each other in the first direction A1. The first and second gate lines Gi−1 and G1 are electrically insulated from the first and second data line Dj and Dj+1 by, for instance, a gate insulating layer 120. In addition, the first and second data lines Dj and Dj+1 may be covered by a protective layer 130.

As shown in FIG. 3, each of the first and second data lines Dj and Dj+1 is bent to is be symmetrical about an imaginary center line (not shown) that crosses a center position between the first and second gate lines Gi−1 and G1. In this manner, the first and second data lines Dj and Dj+1 extend in a third direction towards the imaginary center line, and, thereby, extend in a fourth direction away from the imaginary center line.

According to exemplary embodiments, the first electrode PE, the thin film transistor Tr, and the second electrode CE are disposed on the first insulating substrate 110. As seen in FIGS. 3 and 5, the thin film transistor Tr includes agate electrode GE corresponding to a portion of the gate line Gi, a source electrode SE branched from the first data line Dj, and a drain electrode DE spaced apart from the source electrode SE by a determined distance. It is noted that the source electrode SE and the drain electrode DE may be space apart from, e.g., spaced above) the gate electrode GE, such that the gate electrode GE is disposed between the source electrode SE and the first insulating substrate 110 and between the drain electrode DE and the first insulating substrate 110.

As shown in FIG. 5, the gate electrode GE may be a multilayer (e.g., a double-layer) structure in which two electrode layers are stacked upon one another. A first (e.g., lower) layer M1 of the gate electrode GE may be formed of a transparent conductive material, e.g., aluminum zinc oxide, fluorine doped tin oxide, gallium zinc oxide, indium doped cadmium oxide, indium tin oxide, indium zinc oxide, poly(3,4-ethylenedioxythiophene),poly(3,4-ethylenedioxythiophene):polystyrene sulfonic acid, polyaniline, etc., and a second (e.g., upper) layer M2 formed of, for instance, a metal layer, such as, for example, an aluminum-based metal material, e.g., aluminum (Al) or an aluminum alloy, a silver-based metal material, e.g., silver (Ag) or a silver alloy, a copper-based metal material, e.g., copper (Cu) or a copper alloy, a molybdenum-based metal material, e.g., molybdenum (Mo) or a molybdenum alloy, a is chromium-based metal material, e.g., chromium (Cr) or a chromium alloy, a tantalum-based metal material, e.g., tantalum (Ta) or a tantalum alloy, a titanium-based metal material, e.g., titanium (Ti) or a titanium alloy, etc.

According to exemplary embodiments, the first electrode PE is formed of the same material as the lower layer M1 of the gate electrode GE. The first electrode PE may be disposed in an area defined by the first and second gate lines Gi−1 and G1 and the first and second data lines Dj and Dj+1, and may be integrally formed as a single unitary and individual unit in each pixel area. It is contemplated; however, that the first electrode PE may be configured in any suitable manner.

The gate electrode GE and the first electrode PE are covered by the gate insulating layer 120. An active layer AL is disposed on the gate insulating layer 120, and first and second ohmic contact layers OC1 and OC2 are disposed on the active layer AL and are spaced apart from each other by a determined distance. The source electrode SE is disposed on, for example, the first ohmic contact layer OC1 and the drain electrode DE is disposed on, for instance, the second ohmic contact layer OC2.

In exemplary embodiments, the source and drain electrodes SE and DE may be covered by the protective layer 130. The protective layer 130 includes a first contact hole (or via) CH1 formed therein and configured to expose a portion of the drain electrode DE. As seen in FIG. 5, the protective layer 130 and the gate insulating layer 120 are partially removed from an area adjacent to the first contact hole CH1 to form a second contact hole CH2 through which a portion of the first electrode PE is exposed. To this end, a third (or bridge) electrode BE is disposed on the protective layer 130 to electrically connect the drain electrode DE and the first electrode PE via the first and second contact holes CH1 and CH2.

Referring to FIGS. 3 and 4, the first and second data lines Dj and Dj+1 extend in the second direction A2 and are disposed on the gate insulating layer 120. Each of the first and second data lines Dj and Dj+1 may include a multilayered (e.g., a double-layer) structure including, for instance, a first electrode layer L1 and a second electrode layer L2 stacked upon one another. The first and second data lines Dj and Dj+1 are covered by the protective layer 130.

According to exemplary embodiments, a bump (or protrusion portion) 140 is disposed on the protective layer 130, which is formed along the first and second data lines Dj and Dj+1. In exemplary embodiments, the first substrate 100 may include a plurality of the bumps 140, which may be separated in plural parts in association with each unit pixel or provided with a line shape as the first and second data lines Dj and Dj+1. In addition, when the bump 140 is cut along the first direction A1, which is substantially perpendicular to the direction in which the first and second data lines Dj and Dj+1 extend, the cross section of the bump 140 may exhibit a trapezoidal shape; however, it is contemplated that any other suitable cross-sectional configuration may be utilized. In exemplary embodiments, for example, the bump 140 may have a height h1 in a range from about 2 micrometers to about 4 micrometers, e.g., about 2.5 micrometers to about 3.5 micrometers, such as about 2.9 micrometers to about 3.1 micrometers. To this end, a base of the trapezoidal shape may have a width W3, which may be wider than a width W4 of a corresponding data line (e.g., data line Dj) disposed in association with the bump 140.

According to exemplary embodiments, the second electrode CE includes a shielding electrode portion P1 to cap the bump 140, and a common electrode portion P2 positioned in association with the first electrode PE, such as disposed in a central portion of the first electrode PE. The shielding electrode portion P1 and the common electrode portion P2 is extend along the first and second data lines Dj and Dj+1, and, thereby, are parallel (or substantially parallel) to each other. In addition, the shielding electrode portion P1 and the common electrode portion P2 are electrically connected to each other, and, thereby, are configured to receive the reference voltage Vcom (refer to FIG. 2).

A slit SL is formed between the shielding electrode portion P1 and the common electrode portion P2 of the second electrode CE. When a width of the common electrode portion P2 is referred to as W1 and a width of the slit SL is referred to as W2, the width W1 is smaller than the width W2. The width W1 is in a range from about 1.5 micrometers to about 3 micrometers, e.g., about 1.7 micrometers to about 2.8 micrometers, such as about 2.1 micrometers to about 2.4 micrometers, and the width W2 is in a range from about 2.0 micrometers to about 4 micrometers, e.g., about 2.3 micrometers to about 3.7 micrometers, such as about 2.8 micrometers to about 3.2 micrometers. As an example, when the width W1 is about 3 micrometers, the width W2 is about 3.5 micrometers.

According to exemplary embodiments, the shielding electrode portion P1 has a structure to cap (or otherwise cover) the upper and side surfaces of the bump 140, and an edge of the shielding electrode portion P1 extends to the protective layer 140 to overlap with a portion of the first electrode PE. In this manner, the shielding electrode portion P1 may partially overlap the first electrode PE. For instance, a width W5 in which the shielding electrode portion P1 and the first electrode PE are overlapped with each other may be about 1.5 micrometers.

In exemplary embodiments, the bump 140 includes an organic insulating material having a relatively low dielectric constant, e.g., about 3.2, in order to decrease the capacitance between the shielding electrode portion P1 and the first and second data lines Dj and Dj+1. Further, as described above, since the bump 140 is capped by the shielding electrode portion P1, is an electric field caused, at least in part, by the first and second data lines Dj and Dj+1 may be shielded to, thereby, prevent the liquid crystal molecules of the liquid crystal layer 250 from malfunctioning (e.g., not being aligned as desired) in an area adjacent to the first and second data lines Dj and Dj+1.

According to exemplary embodiments, the shielding electrode portion P1 is formed along the upper and side surfaces of the bump 140 to have a protrusion shape protruded toward the second substrate 200. In this manner, the liquid crystal molecules of the liquid crystal layer 250 disposed adjacent to the second substrate 200 may be easily controlled by an electric field generated between the shielding electrode portion P1 disposed on the side surface of the bump 140 and the first electrode PE. This portion of the electric field may increase the transmittance of the image display part 300. Further, a driving voltage used to drive the liquid crystal molecules of the liquid crystal layer 250 may be prevented from being increased, as is typically done in association with conventional, lateral electric field driven liquid crystal displays. In other words, the above-noted portion of the electric field may be utilized to decrease the driving voltage used to control liquid crystal molecules of the liquid crystal layer 250.

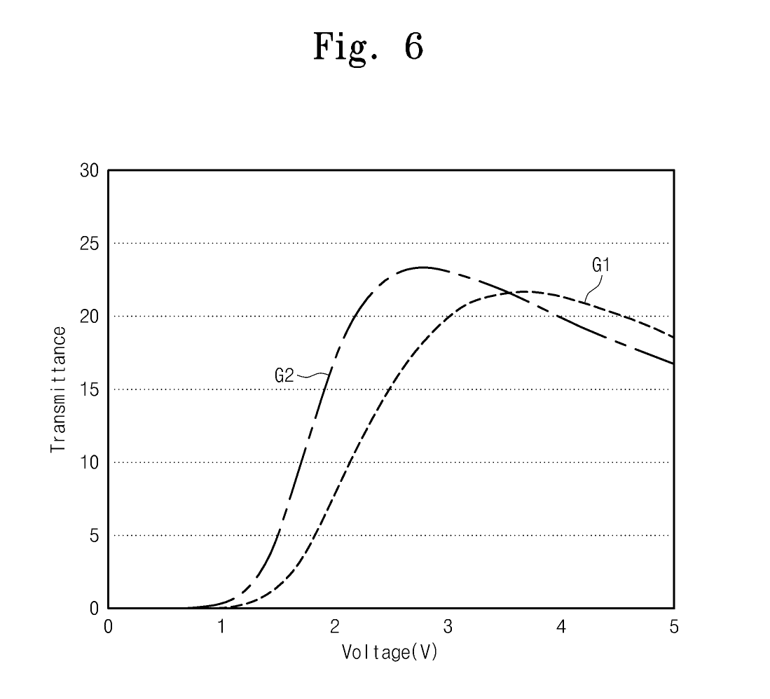

FIG. 6 is a graph comparing transmittance with driving voltage, according to exemplary embodiments.

As seen in FIG. 6, a first graph G1 represents a variation of the transmittance as a function of the driving voltage in a conventional, lateral electric field driven liquid crystal display, and a second graph G2 represents a variation of the transmittance as a function of the driving voltage in the image display part 300 of FIG. 3. As can be readily appreciated from FIG. 6, when transmittances measured at the same driving voltage are compared to each other, the transmittance of the image display part of FIG. 3, in which the shielding electrode portion P1 is is formed on the upper and side surfaces of the bump 140 to control the liquid crystal molecules of the liquid crystal layer 250, is greater than the transmittance of the conventional liquid crystal display. Accordingly, the image display part 300 of FIG. 3 may obtain various levels of transmittance using a lower driving voltage than a conventional liquid crystal display. As a result, the transmittance may be improved and the power consumption may be reduced.

Adverting to FIG. 4, the second substrate 200 includes a second insulating substrate 210 formed of any suitable material, such as, for example, transparent glass, plastic, etc., a plurality of color filters 230 disposed on the second insulating substrate 210, and a light blocking member (e.g., black matrix) 220 disposed between the color filters 230. As seen in FIG. 4, two color filters 230 adjacent to each other are spaced apart from each other by the black matrix 220. It is noted, however, that the two adjacent color filters 230 may partially overlap respective portions of the black matrix 220, but may still remain separated from one another in another portion of the black matrix 220. An overcoating layer 240 may be utilized to remove a step difference caused by the space between the adjacent color filters 230. In this manner, the second substrate 200 further includes the overcoating layer 240 to cover the color filters 230 and the black matrix 220.

According to exemplary embodiments, the second substrate 200 faces the first substrate 100 and is coupled to the first substrate 100. To this end, the liquid crystal layer 250 is disposed between the first and second substrates 100 and 200. A cell gap of the liquid crystal layer 250 may be referred to as “d1.” In this manner, the cell gap d1 may be greater than the height h1 of the bump 140. For example, when the cell gap d1 is about 4 micrometers, the height h1 may be about 3 micrometers.

In exemplary embodiments, when agate signal is applied to a pixel PX through is the second gate line G1, the thin film transistor Tr is “turned on” in response to the gate signal. A data voltage applied to the first data line Dj is applied to the first electrode PE through the drain electrode DE of the “turned-on” thin film transistor Tr. The data voltage corresponds to the driving voltage used to control the liquid crystal molecules of the liquid crystal layer 250. In this manner, the first electrode PE applied with the data voltage is configured to generate an electric field in cooperation with the second electrode CE applied with the reference voltage Vcom. To this end, a direction of the liquid crystal molecules of the liquid crystal layer 250, which are disposed on (or near) the first electrode PE and the second electrode CE, may be controlled in one or more desired manners. According to the controlled direction of the liquid crystal molecules, light passing through the liquid crystal layer 250 may be polarized.

It is noted that, according to exemplary embodiments, the first electrode PE and the second electrode CE form the liquid crystal capacitor Clc (refer to FIG. 1) using the liquid crystal layer 250 as a dielectric substance disposed therebetween to maintain the applied voltage for a duration after the thin film transistor Tr is “turned off.”

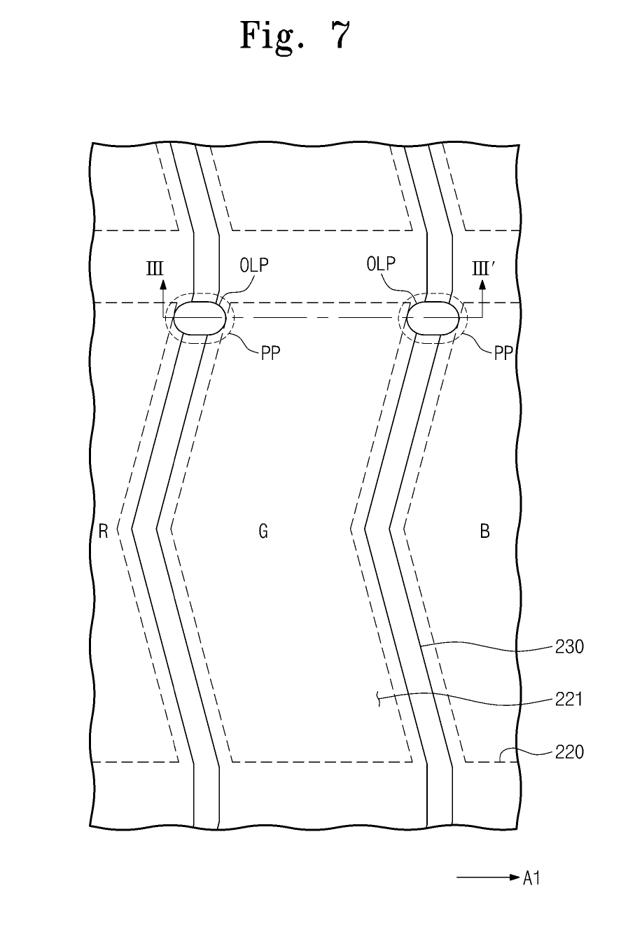

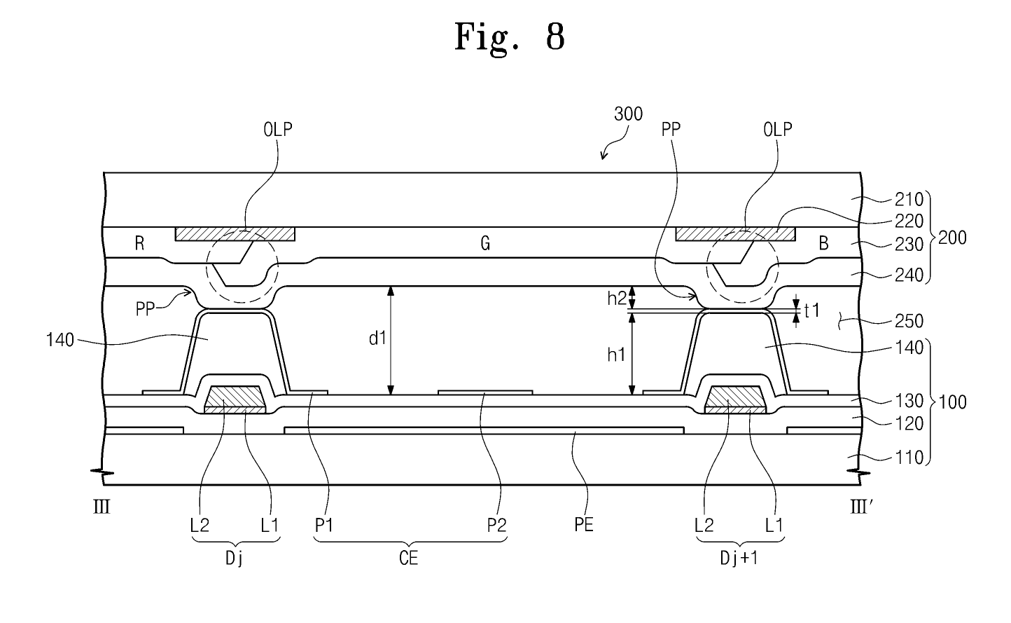

FIG. 7 is a plan view of a second substrate of a liquid crystal display, according to exemplary embodiments. FIG. 8 is a cross-sectional view of the liquid crystal display of FIG. 7 taken along sectional line III-III′.

Referring to FIGS. 7 and 8, the black matrix 220 is disposed on the second insulating substrate 210. The black matrix 220 includes a plurality of openings 221 formed therethrough to respectively correspond to the pixel areas of the first insulating substrate 110.

According to exemplary embodiments, various color pixels, such as red, green, and blue color pixels R, G, and B, are disposed on the second insulating substrate 210 to respectively correspond to the openings 221. The red, green, and blue color pixels R, G, and B is are sequentially arranged in the first direction A1. Two color pixels adjacent to each other are spaced apart from each other in the first direction A1, except for a portion thereof. That is, the adjacent two color pixels are overlapped with each other in the portion. For example, the portion in which the two color pixels are overlapped with each other may correspond to a portion disposed in an area in which the black matrix 220 is formed. The portion in which the two color pixels are overlapped with each other and protruded may be referred to as an overlap portion OLP. In this manner, the overcoating layer 240 that covers the color filters 230 may also have a protruded shape along the overlap portion OLP.

According to exemplary embodiments, a protrusion portion PP configured to include the overlap portion OLP and the overcoating layer 240 is disposed on the second substrate 200 and protrudes toward the first substrate 100. The protrusion portion PP may be disposed between the black matrix 220 and the bump 140 of the first substrate 100. In exemplary embodiments, the protrusion portion PP makes contact with the layer disposed on the upper surface of the bump 140, e.g., the shielding electrode portion P1 of the second electrode CE. As such, the cell gap d1 of the liquid crystal layer 250 may be determined based on the relative thicknesses of the protrusion portion PP and the bump 140. That is, when the cell gap of the liquid crystal layer 250, the height of the bump 140, a height of the protrusion portion PP, and a thickness of the shielding electrode portion P1 are “d1,” “h1,” “h2,” and “t1,” respectively, the cell gap d1 is equal to a sum of the height h1, the height h2, and the thickness t1.

Although not shown in figures, when one or more alignment layers are provided in association with the first and second substrates 100 and 200, the cell gap d1 may be equal to a sum of the height h1, the height h2, the thickness t1, and the respective thicknesses of the alignment layers.

As shown in FIG. 7, the protrusion portion PP has a dot shape in the form of an oval or circular shape when viewed in a plan view. It is contemplated, however, that the protrusion portion may have any other suitable shape when viewed in a plan view.

As described above, when the cell gap d1 is determined by the bump 140 and the protrusion portion PP, a separate spacer, which is typically utilized to maintain the cell gap d1, may be omitted, and a process of forming the spacer may be omitted when the image display part 300 is manufactured. This may not only simplify the manufacturing process of the image display part 300, but may also reduce the costs associated therewith.

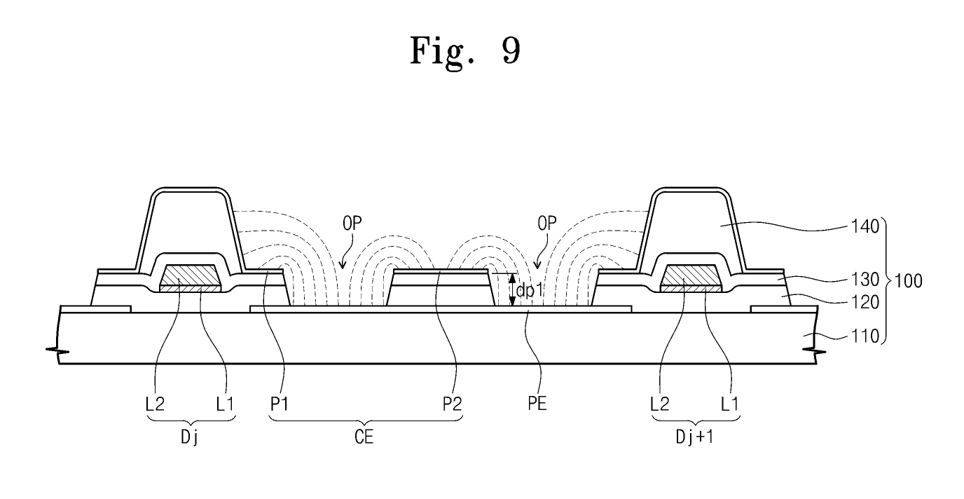

FIG. 9 is a cross-sectional view of a first substrate, according to exemplary embodiments. The various components of the first substrate 100 illustrated in FIG. 9 are substantially similar to the components of the first substrate 100 shown in FIG. 4. As such, to avoid obscuring exemplary embodiments described herein, duplicative descriptions are avoided and differences are described in more detail.

Referring to FIG. 9, the silt SL (refer to FIG. 4) is provided between the shielding electrode portion P1 and the common electrode portion P2 of the second electrode CE. The gate insulating layer 120 and the protective layer 130 are provided with an opening portion OP formed therethrough and corresponding to the slit SL to expose a portion of the first electrode PE. The opening portion OP has a depth dp1 determined based on a thickness of each of the gate insulating layer 120 and the protective layer 130. In exemplary embodiments, the depth dp1 of the opening portion OP may be about 0.6 micrometers.

As described above, when the opening portion OP is provided to correspond to the slit SL, the portion of the first electrode PE, which corresponds to the slit SL, is exposed therethrough. In this manner, when an alignment layer (not shown) is disposed on the second is electrode CE, the alignment layer may directly contact the first electrode PE exposed through the opening portion OP. To this end, electric charges, e.g., impurity ions, may be prevented from being concentrated on the alignment layer, which, thereby, may prevent (or otherwise reduce) the potential of an afterimage from occurring.

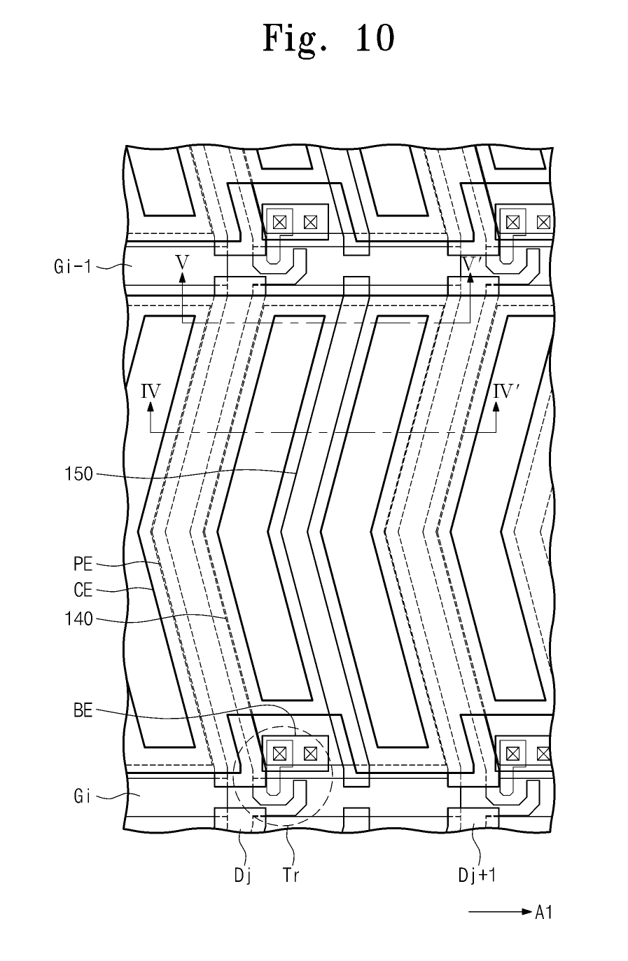

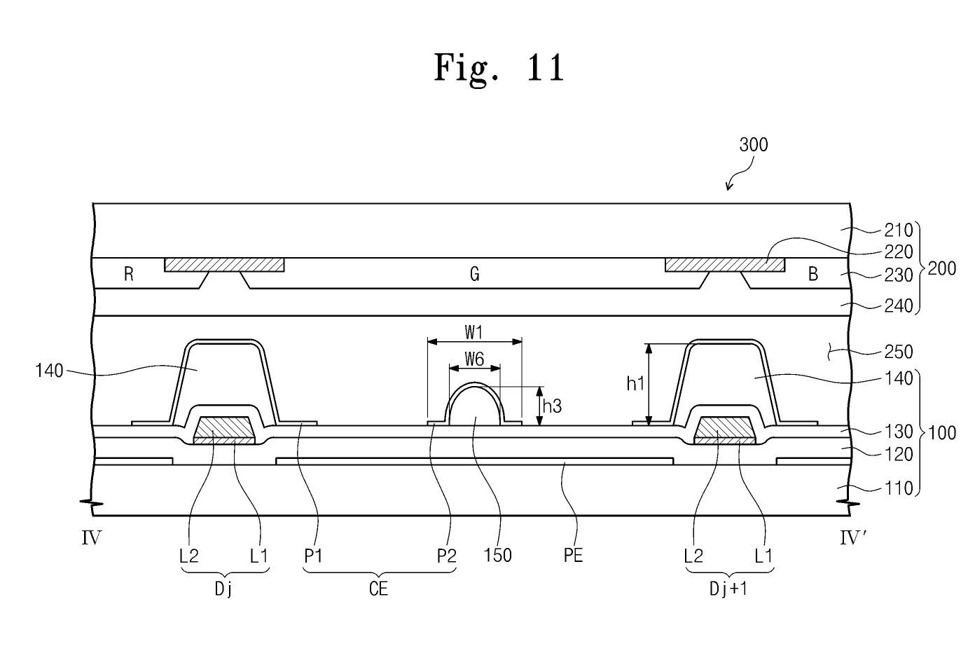

FIG. 10 is a plan view of a liquid crystal display panel, according to exemplary embodiments. FIG. 11 is a cross-sectional view of the image display panel of FIG. 10 taken along sectional line IV-IV′. The various components of the liquid crystal display panel of FIGS. 10 and 11 are substantially the same as the components described in association with FIGS. 3-7. As such, to avoid obscuring exemplary embodiments described herein, duplicative descriptions are avoided and differences are described in more detail.

Referring to FIGS. 10 and 11, a protrusion bar 150 is disposed directly under the common electrode portion P2. In this manner, the common electrode portion P2 and the protrusion bar 150 are each protruded towards the second substrate 200. In this manner, the protrusion bar 150 extends along the first and second data lines Dj and Dj+1. For instance, the protrusion bar 150 may be separated into plural parts in the unit of a pixel or have a line shape extended in the direction in which the first and second data lines Dj and Dj+1 extend. In this manner, the protrusion bar 150 may extend in the third direction towards the imaginary center line of a data line (e.g., data line Dj), and, thereby, extend in the fourth direction away from the imaginary center line. In addition, the protrusion bar 150 may exhibit any suitable cross-sectional shape, such as a semi-elliptical shape or a semi-circular shape, when the protrusion bar 150 is cut along the first direction A1 substantially perpendicular to the first and second data lines Dj and Dj+1.

When a width of the common electrode portion P2 in the first direction A1 is “W1” and a width of the protrusion bar 150 in the first direction A1 is “W6,” the width W1 is greater than the width W6. In exemplary embodiments, when the width W1 is about 3 micrometers, the width W6 is about 2 micrometers. In exemplary embodiments, when a height of the bump 140 is “h1” and a height of the protrusion bar 150 is “h3,” the height h3 is smaller than the height h1. As an example, when the height h1 is about 3 micrometers, the height h3 is about 1 micrometer.

In conventional lateral electric field driven liquid crystal display devices, since the first and second electrodes PE and CE are disposed on the first substrate 100, liquid crystal molecules of an associated liquid crystal layer are typically disposed adjacent to the second substrate 200, and, as such, are usually difficult to control. In addition, when the driving voltage is increased to resolve (or otherwise reduce) the above-noted issue, power consumption is increased.

According to exemplary embodiments, however, when the protrusion bar 150 is formed under the common electrode portion P2, the common electrode portion P2 has a shape protruded towards the second substrate 200. As described above, since the common electrode portion P2 is protruded towards the second substrate 200, the liquid crystal molecules of the liquid crystal layer 250 disposed adjacent to the second substrate 200 may be more easily controlled. As such, a driving voltage may be prevented from being increased, and, in this manner, power consumption may be reduced.

In exemplary embodiments, as the height h3 of the protrusion bar 150 becomes larger, the liquid crystal molecules of the liquid crystal layer 250 disposed adjacent to the second substrate 200 may be more easily controlled. It is noted, however, that the height h3 of the protrusion bar 150 may be limited to the height h1 of the bump 140, as the width W6 of the is protrusion bar 150 is restricted to an area between adjacent bumps 140. In this manner, the height h3 of the protrusion bar 150 may, according to exemplary embodiments, be smaller than the height h1 of the bump 140.

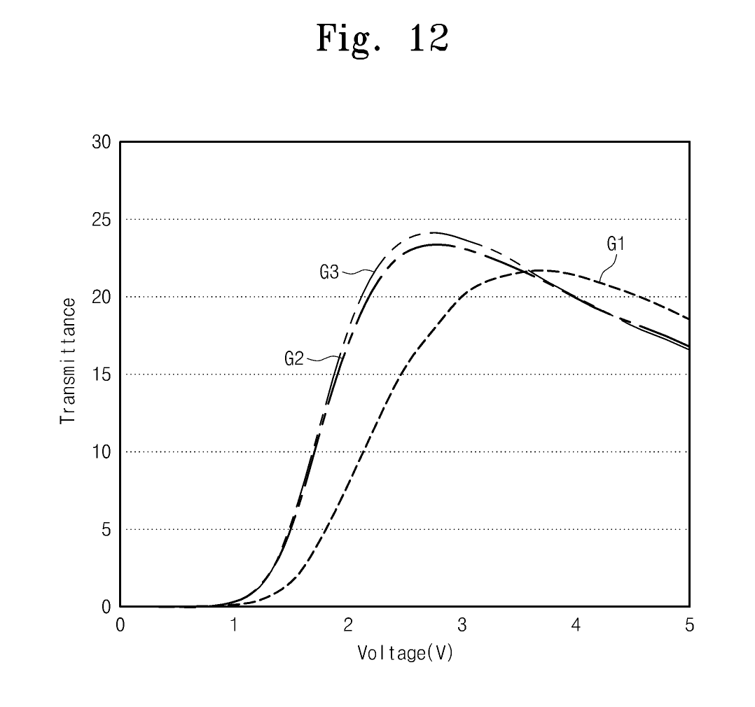

FIG. 12 is a graph comparing transmittance with driving voltage, according to exemplary embodiments.

As seen in FIG. 12, a first graph G1 represents a variation of the transmittance as a function of the driving voltage in a conventional, lateral electric field driven liquid crystal display, a second graph G2 represents a variation of the transmittance as a function of the driving voltage in the liquid crystal display of FIGS. 3 and 4, and a third graph G3 represents a variation of the transmittance as a function of the driving voltage in the liquid crystal display of FIGS. 10 and 11.

As can be readily appreciated from FIG. 12, when transmittances measured at the same driving voltage are compared to each other, the transmittance of image display part 300 of FIGS. 3 and 4, in which the shielding electrode portion P1 is formed on the upper and side surfaces of the bump 140 to control the liquid crystal molecules of the liquid crystal layer 250, is higher than the transmittance of the conventional liquid crystal display. In addition, when transmittances measured at the same driving voltage are compared to each other, the transmittance of the image display part 300 of FIGS. 10 and 11, in which the protrusion bar 150 is formed directly under the common electrode portion P2 to control the liquid crystal molecules of the liquid crystal layer 250, is greater than the transmittance of the conventional liquid crystal display and the transmittance of the image display part 300 of FIGS. 3 and 4. Accordingly, the image display part 300 of FIGS. 10 and 11 may obtain various levels of transmittance using a lower driving voltage lower than those of a conventional liquid crystal display and the image is display part 300 of FIGS. 3 and 4. As a result, the transmittance may be improved and the power consumption may be reduced.

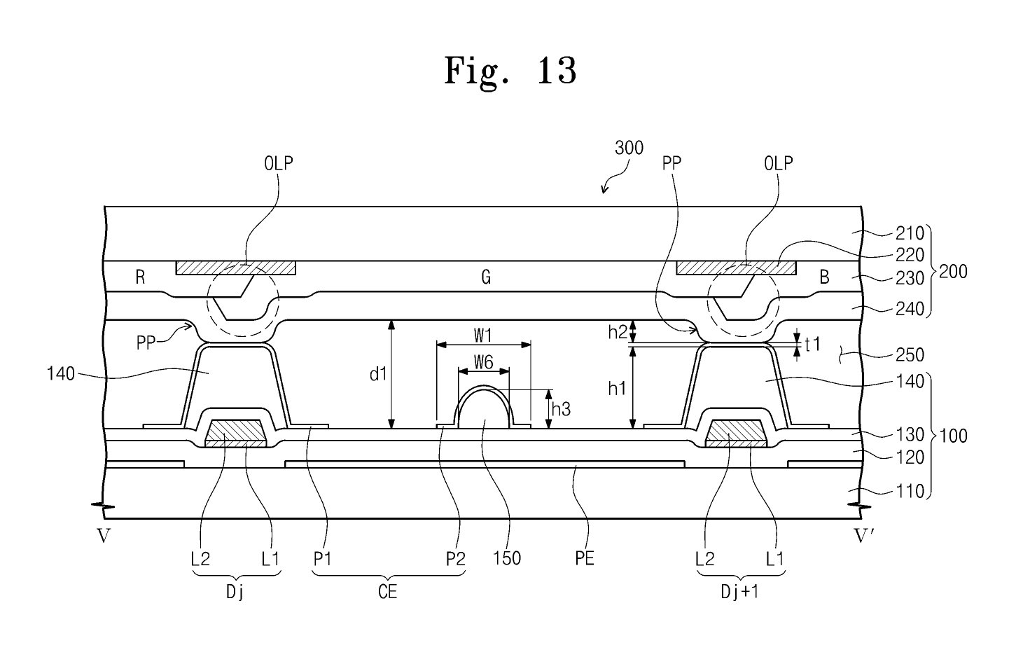

FIG. 13 is a cross-sectional view of the liquid crystal display of FIG. 10 taken along sectional line V-V′, according to exemplary embodiments. Various components of the liquid crystal display illustrated in FIG. 13 are substantially similar to the components of the image display panel shown in FIGS. 4, 8, and 11. As such, to avoid obscuring exemplary embodiments described herein, duplicative descriptions are avoided and differences are described in more detail.

Referring to FIG. 13, two color pixels adjacent to each other are overlapped with each other in a portion. For example, the portion in which the two color pixels are overlapped with each other may correspond to a portion disposed in an area in which the black matrix 220 is formed. The portion in which the two color pixels are overlapped with each other and protruded may be referred to as an overlap portion OLP. In this manner, the overcoating layer 240 formed on the color filters 230 may also have a protruded shape along the overlap portion OLP.

According to exemplary embodiments, a protrusion portion PP configured to include the overlap portion OLP and the overcoating layer 240 is disposed on the second substrate 200 and protrudes toward the first substrate 100. The protrusion portion PP may be disposed between the black matrix 220 and the bump 140 of the first substrate 100. In exemplary embodiments, the protrusion portion PP makes contact with the layer disposed on the upper surface of the bump 140, e.g., the shielding electrode portion P1 of the second electrode CE. As such, the cell gap d1 of the liquid crystal layer 250 may be determined based on the relative thicknesses of the protrusion portion PP and the bump 140. As described above, when the cell gap d1 is determined by the bump 140 and the protrusion portion PP, a separate spacer, which is is typically utilized to maintain the cell gap d1, may be omitted, and a process of forming the spacer may be omitted when the image display part 300 is manufactured. This may not only simplify the manufacturing process of the image display part 300, but may also reduce the costs associated therewith.

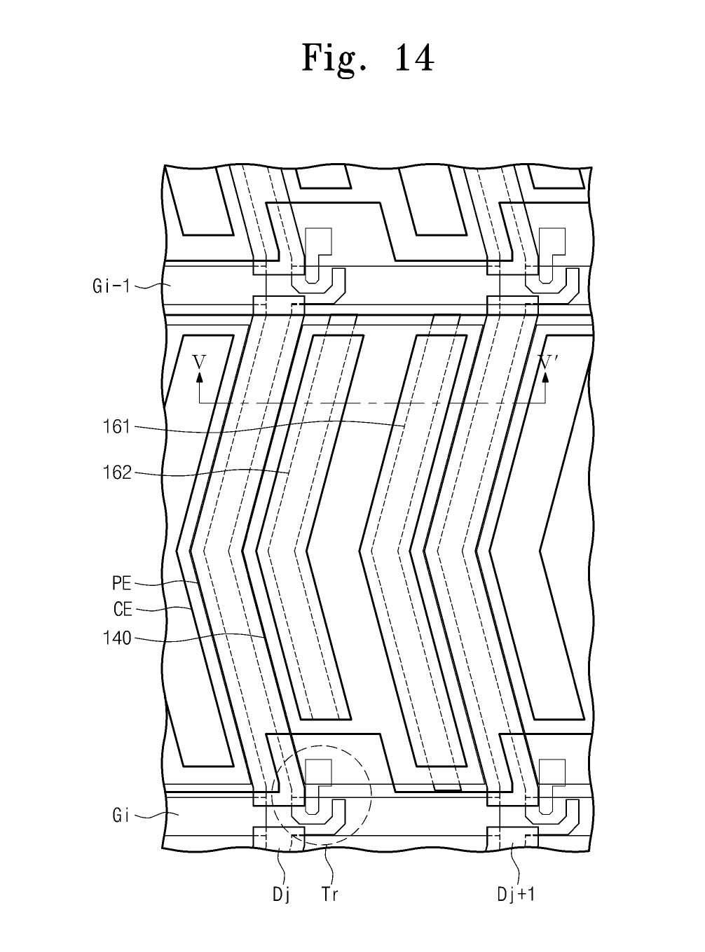

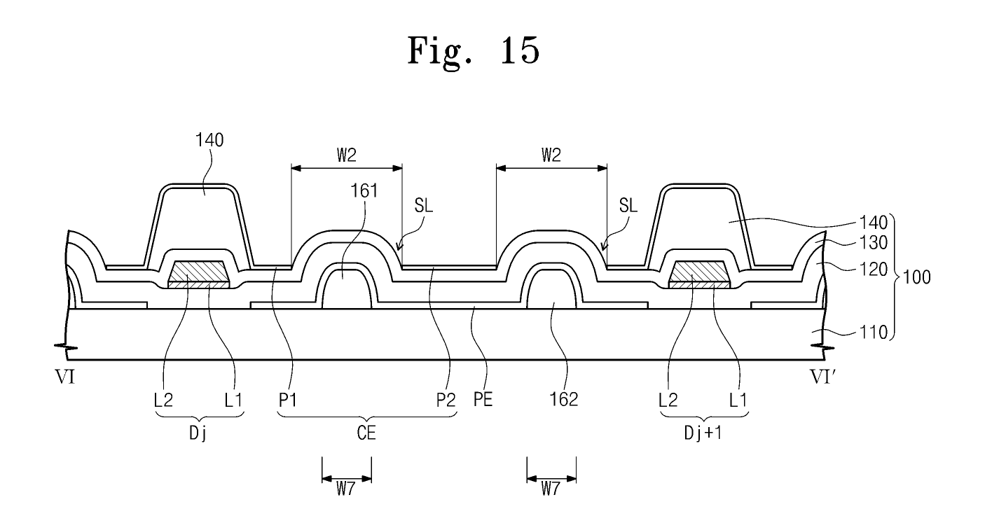

FIG. 14 is a plan view of a first substrate, according to exemplary embodiments. FIG. 15 is a cross-sectional view of the first substrate of FIG. 14 taken along sectional line VI-VI′. Various components of the first substrate 100 illustrated in FIGS. 14 and 15 are substantially similar to the components of the first substrate 100 shown in FIGS. 4, 11, and 13. As such, to avoid obscuring exemplary embodiments described herein, duplicative descriptions are avoided and differences are described in more detail.

Referring to FIGS. 14 and 15, first and second protrusion bars 161 and 162 are disposed directly under the first electrode PE. In this manner, the first electrode PE and the first and second protrusion bars 161 and 162 are protruded towards the second substrate 200. Further, the first and second protrusion bars 161 and 162 are spaced apart from each other in the first direction A1. Each of the first and second protrusion bars 161 and 162 is provided to correspond to the slit SL formed in the second electrode CE. That is, each of the first and second protrusion bars 161 and 162 protrude through corresponding slits SL. When a width of the slit SL in the first direction A1 is “W2” and a width of each of the first and second protrusion bars 161 and 162 in the first direction A1 is “W7,” the width W2 is greater than the width W7. For instance, when the width W2 is about 3.5 micrometers, the width W7 is about 2 micrometers.

According to exemplary embodiments, the first and second protrusion bars 161 and 162 extend along the first and second data lines Dj and Dj+1. In other words, the first and second protrusion bars 161 and 162 may extend in the third direction towards the imaginary is center line of a data line (e.g., data line Dj), and, thereby, may further extend in the fourth direction away from the imaginary center line. The first and second protrusion bars 161 and 162 may be separated into plural parts in the unit of a pixel or have a line shape corresponding to the shape of the first and second data lines Dj and Dj+1.

In addition, each of the first and second protrusion bars 150 may exhibit any suitable cross-sectional shape, such as a semi-elliptical shape, a semi-circular shape, etc., when the first and second protrusion bars 150 are cut along the first direction A1 substantially perpendicular to the first and second data lines Dj and Dj+1. In exemplary embodiments, the first and second protrusion bars 161 and 162 are disposed on the first insulating substrate 110 and formed of any suitable organic insulating material.

According to exemplary embodiments, when the first and second protrusion bars 161 and 162 are formed under the first electrode PE, the first electrode PE is also protruded towards the second substrate 200. As described above, since the first electrode PE is protruded towards the second substrate 200, the liquid crystal molecules of the liquid crystal layer 250 disposed adjacent to the second substrate 200 may be more easily controlled. As such, a driving voltage may be prevented (or otherwise reduced) from being increased. This may, in turn, reduce the power consumption of an associated image display part 300.

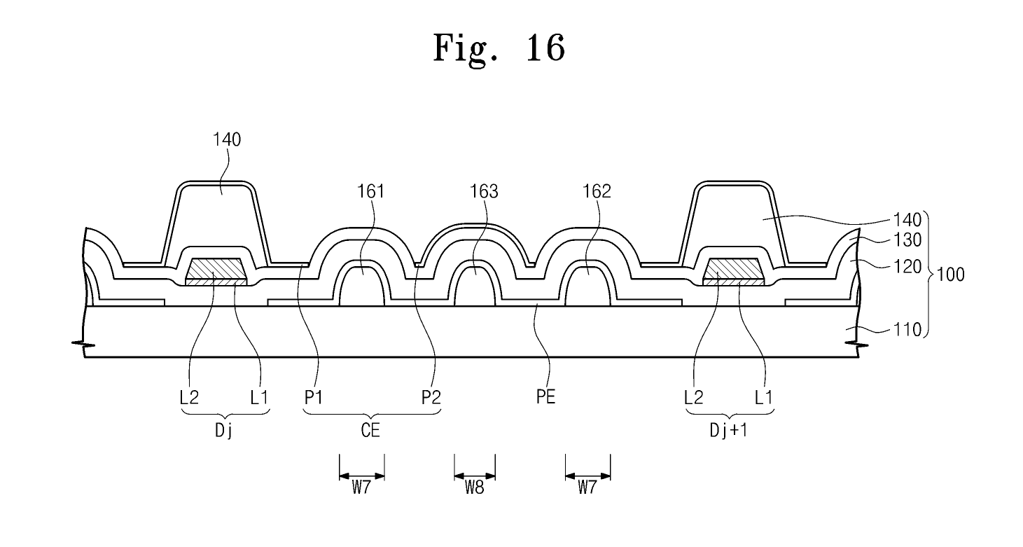

FIG. 16 is a cross-sectional view showing a first substrate according to an exemplary embodiment of the present disclosure. Various components of the first substrate 100 illustrated in FIG. 16 are substantially similar to the components of the first substrate 100 shown in FIGS. 4, 11, and 13-15. As such, to avoid obscuring exemplary embodiments described herein, duplicative descriptions are avoided and differences are described in more detail.

Referring to FIG. 16, first, second, and third protrusion bars 161, 162, and 163 are is disposed directly under the first electrode PE, and each are protruded towards the second substrate 200 and spaced apart from each other in the first direction A1. Each of the first and second protrusion bars 161 and 162 are disposed in correspondence with a respective slit SL formed in the second electrode CE. The third protrusion bar 163 is disposed in correspondence with the common electrode portion P2. In other words, each of the first and second protrusions 161 and 162 protrude through corresponding slits SL, whereas the common electrode portion P2 of the second electrode CE is disposed on the third protrusion 163.

According to exemplary embodiments, when a width of each of the first and second protrusion bars 161 and 162 in the first direction A1 is “W7” and a width of the third protrusion bar 163 in the first direction A1 is “W8,” the width W7 is greater than the width W8. For instance, when the width W7 is about 2 micrometers, the width W8 is about 1.5 micrometers.

As seen in FIG. 16, the first, second, and third protrusion bars 161, 162, and 163 are disposed between the first insulating substrate 110 and the first electrode PE. The first electrode PE is protruded towards the second substrate 200 in association with the first, second, and third protrusion bars 161, 162, and 163, and the common electrode portion P2 is protruded towards the second substrate 200 in association with the third protrusion bar 163. To this end, the third protrusion bar 163 is disposed between the first and second protrusion bars 161 and 162 in the first direction A1. In this manner, the liquid crystal molecules of the liquid crystal layer 250 disposed adjacent to the second substrate 200 may be more easily controlled, and, as such, a driving voltage may be prevented (or otherwise reduced) from being increased. This, in turn, may reduce the power consumption of an associated image display part 300.

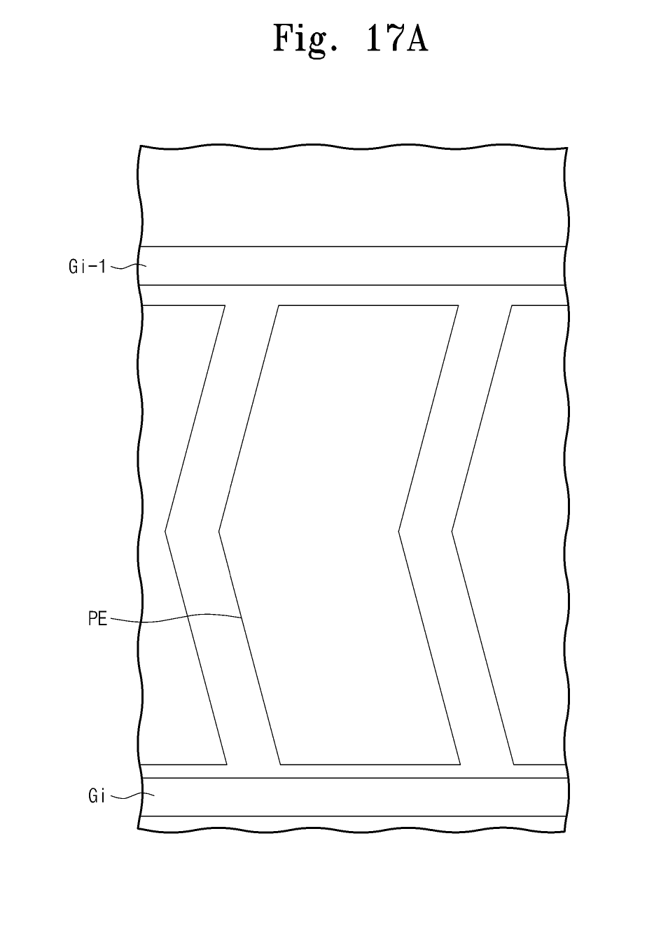

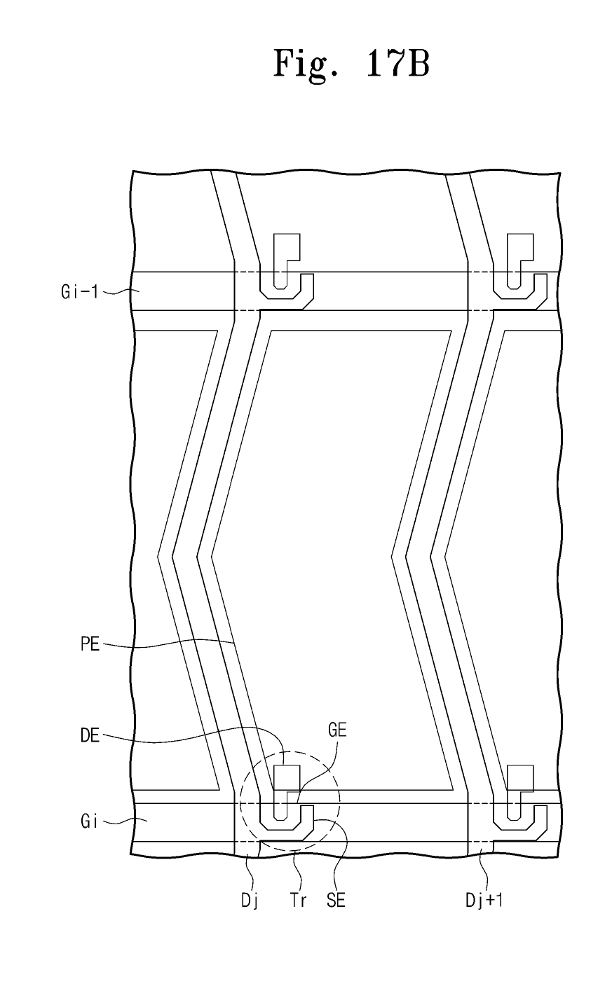

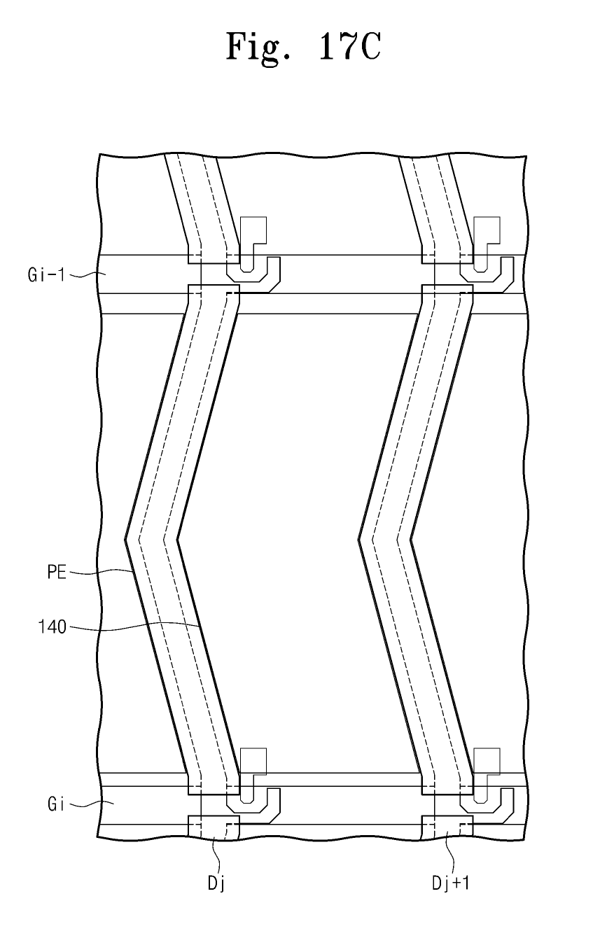

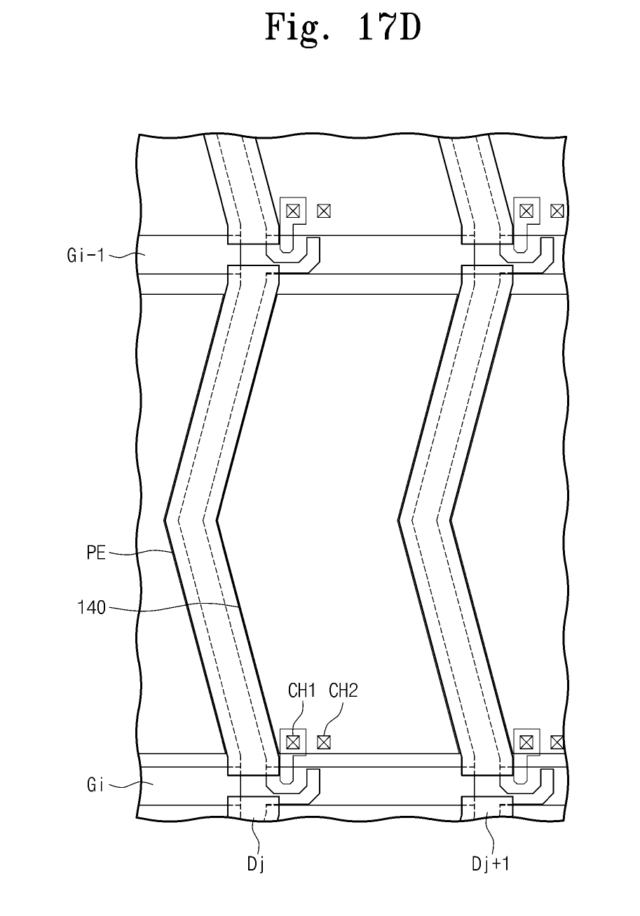

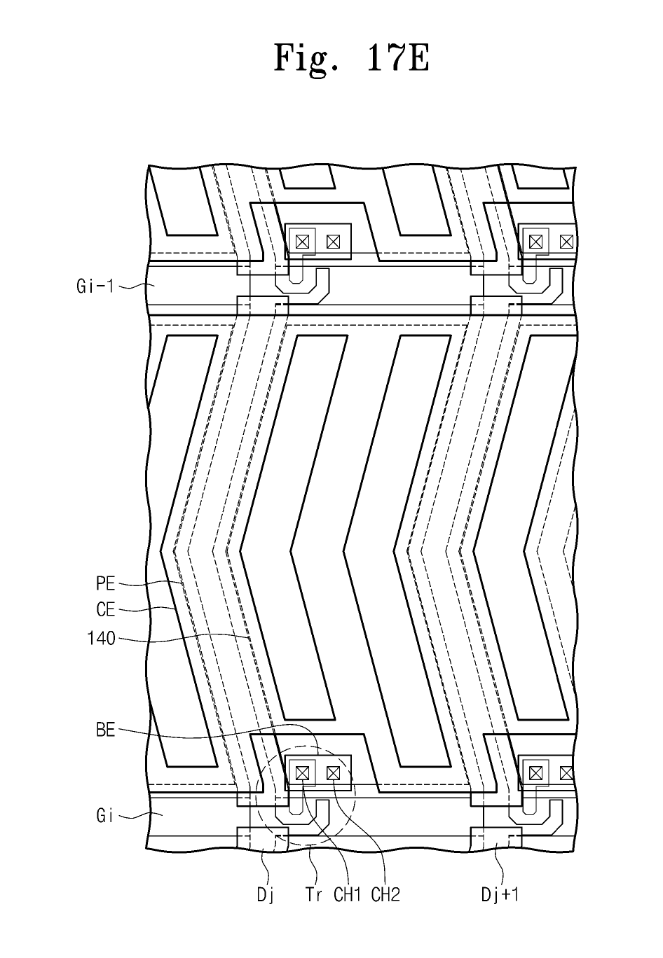

FIGS. 17A-17E are respective plan views of the first substrate of FIG. 3 at various stages of manufacture, according to exemplary embodiments.

Referring to FIG. 17A, first and second metal layers are formed (e.g., sequentially formed) on the first insulating substrate 110 and patterned using a first mask to form the first and second gate lines Gi−1 and G1 and the first electrode PE on the first insulating substrate 110. One of the first and second metal layers is formed of, for example, a transparent conductive material, such as aluminum zinc oxide, fluorine doped tin oxide, gallium zinc oxide, indium doped cadmium oxide, indium tin oxide, poly(3,4-ethylenedioxythiophene),poly(3,4-ethylenedioxythiophene):polystyrene sulfonic acid, polyaniline, etc., and the other one of the first and second metal layers is formed of an aluminum-based metal material, e.g., aluminum (Al) or an aluminum alloy, a silver-based metal material, e.g., silver (Ag) or a silver alloy, a copper-based metal material, e.g., copper (Cu) or a copper alloy, a molybdenum-based metal material, e.g., molybdenum (Mo) or a molybdenum alloy, a chromium-based metal material, e.g., chromium (Cr) or a chromium alloy, a tantalum-based metal material, e.g., tantalum (Ta) or a tantalum alloy, a titanium-based metal material, e.g., titanium (Ti) or a titanium alloy, etc.

In exemplary embodiments, the first and second gate lines Gi−1 and G1 have a multilayered (e.g., double-layered) structure in which the first and second metal layers are sequentially stacked. The first electrode PE, however, has a single-layer structure of the transparent conductive material of the first and second metal layers.

Although not shown in figures, the first and second gate lines Gi−1 and G1 and the first electrode PE are covered by the gate insulating layer 120. The gate insulating layer 120 is formed of any suitable insulating material, such as, for example, silicon nitride (SiNx), silicon oxide (SiOx), etc.

Referring to FIG. 17B, third and fourth metal layers are formed (e.g., sequentially formed) on the gate insulating layer 120 and patterned using a second mask to form the source is electrode SE, the drain electrode DE, and the first and second data lines Dj and Dj+1. In exemplary embodiments, the third metal layer is formed of molybdenum, chromium, tantalum, or titanium, and the fourth metal layer is formed of copper. To this end, the portions of the first and second gate lines Gi−1 and G1, which respectively face the source electrode SE and the drain electrode DE, serve as gate electrodes.

In addition, although not shown in figures, the active layer AL (refer to FIG. 5), may be formed of hydrogenated amorphous silicon, polysilicon, an oxide-based material, etc. The first and second ohmic contact layers OC1 and OC2 are formed between the gate electrode GE and the source electrode SE and between the gate electrode GE and the drain electrode DE. It is noted, however, that the active layer AL and the first and second ohmic contact layers OC1 and OC2 may be formed by patterning the third metal layer using the second mask. In this manner, the thin film transistor Tr is formed.

Although not shown in figures, the source electrode SE, the drain electrode DE, and the first and second data lines Dj and Dj+1 are covered by the protective layer 130.

Referring to FIG. 17C, the organic insulating material having the low dielectric constant equal to or smaller than about 3.0 is formed on the protective layer 130. When the organic insulating material is patterned using a third mask, the bump 140 is formed along the first and second data lines Dj and Dj+1. The bump 140 may be separated into plural parts in the unit of a pixel or have a line shape extended in the directions associated with the first and second data lines Dj and Dj+1.

Referring to FIG. 17D, the protective layer 130 is patterned using a fourth mask. The first contact hole CH1 and the second contact hole CH2 are formed through the protective layer 130 to expose the portion of the drain electrode DE and the portion of the first electrode PE, respectively. The transparent conductive material is formed on the protective layer 130 and the bump 140 and patterned using a fifth mask. In this manner, the second electrode CE and the bridge electrode BE are formed.

Referring to FIG. 17E, the second electrode CE includes the shielding electrode portion P1 to cap the bump 140 and the common electrode portion P2 disposed in association with, for instance, a center position of the first electrode PE. The shielding electrode portion P1 and the common electrode portion P2 extend along the first and second data lines Dj and Dj+1 to be parallel (or substantially parallel) to each other. The slit SL is formed between the shielding electrode portion P1 and the common electrode portion P2. The shielding electrode portion P1 is configured to cap (or otherwise cover) the upper and side surfaces of the bump 140. The edges of the shielding electrode portion P1 are overlapped with respective portions of the first electrode PE.

According to exemplary embodiments, the bridge electrode BE directly contacts the drain electrode DE through the first contact hole CH1 and directly contacts the first electrode PE through the second contact hole CH2. In this manner, the drain electrode DE and the first electrode PE may be electrically connected to each other via the bridge electrode BE.

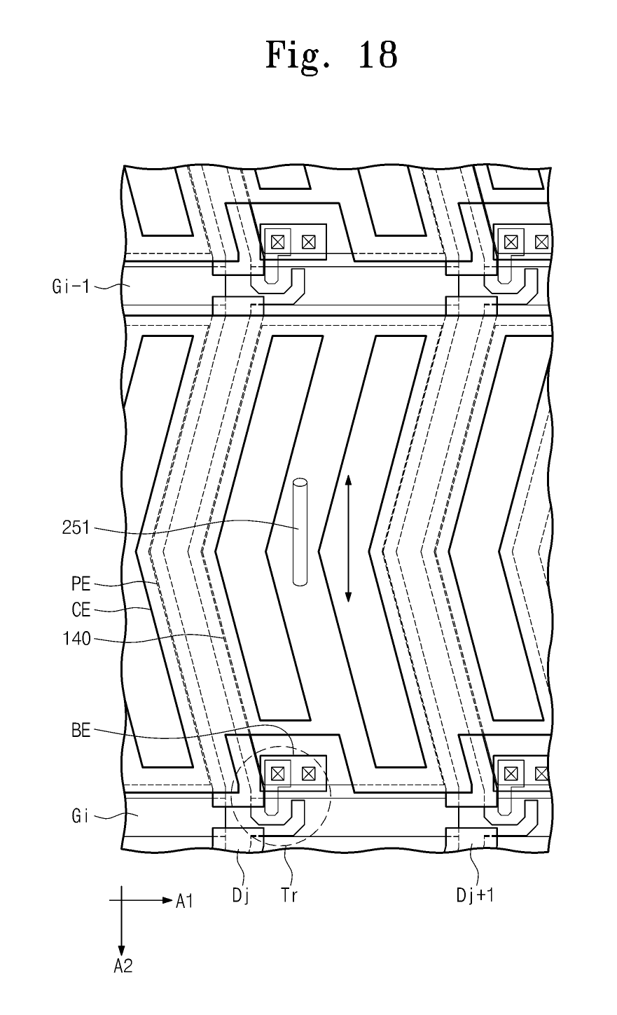

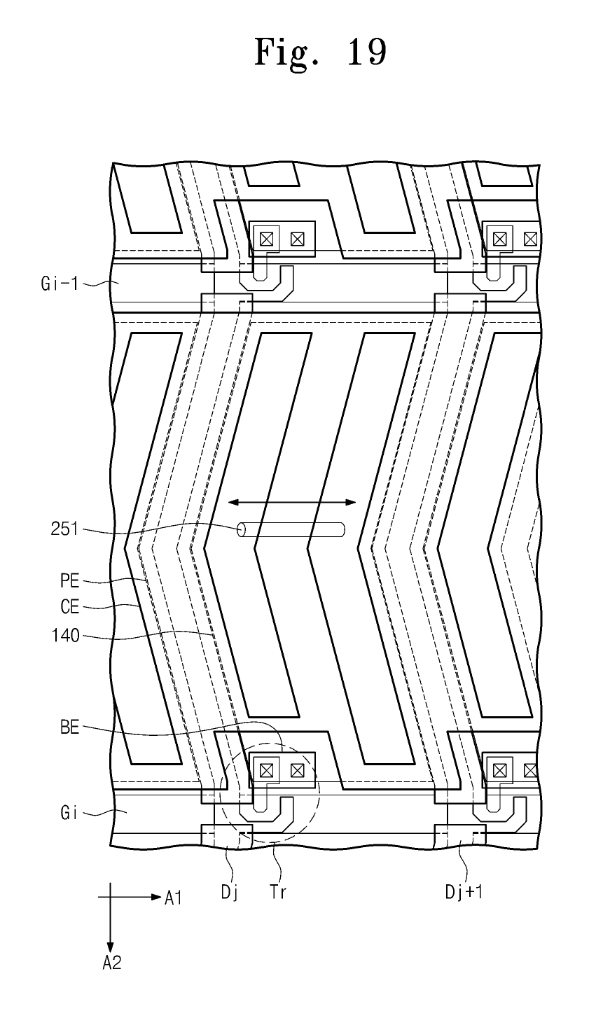

FIG. 18 is a plan view of an alignment direction of an optical alignment layer, according to exemplary embodiments. FIG. 19 is a plan view of an alignment direction of an optical alignment layer, according to exemplary embodiments.

Referring to FIGS. 18 and 19, the alignment layer is disposed on the second electrode CE. The alignment layer may include, for example, a polymer material in which a decomposition, dimerization, or isomerization reaction occurs by light (e.g., an ultraviolet ray, a laser, etc.). In addition, the alignment layer may include oligomer cinnamate mixed with is polymer-based cinnamate. It is contemplated; however, than any other suitable alignment layer material may be utilized.

According to exemplary embodiments, the alignment layer is aligned by the light without a rubbing process. The light alignment process does not need to perform a process of planarizing a lower layer disposed under the alignment layer. In this manner, although the first substrate 100 is not flat, alignment defects may be prevented (or otherwise reduced) from occurring as a result of, for example, the bump 140.

As shown in FIG. 18, when the liquid crystal molecules 251 are of a positive type, the alignment layer is optically aligned in the second direction A2 in which the first and second data lines Dj and Dj+1 substantially extend. As shown in FIG. 19, when the liquid crystal molecules 251 are of a negative type, the alignment layer is optically aligned in the first direction A1 in which the first and second gate lines Gi−1 and G1 substantially extend.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A liquid crystal display, comprising:
a first substrate comprising:
a first base substrate,
a gate line disposed on the first base substrate,
a first electrode disposed on the first base substrate, the first electrode configured to receive a driving voltage,
a data line crossing the gate line,
a bump disposed on and formed along the data line, and
a second electrode comprising a shielding electrode portion disposed on the bump and a common electrode portion disposed in association with a center portion of the first electrode, the second electrode configured to receive a reference voltage;
a second substrate comprising:
a second base substrate facing the first base substrate, and
color filters disposed on the second base substrate; and
a liquid crystal layer disposed between the first substrate and the second substrate,
wherein adjacent color pixels partially overlap one another in a region comprising the bump to provide a protrusion portion protruded from the second base substrate towards the first base substrate.

2. The liquid crystal display of claim 1, wherein a cell gap of the liquid crystal layer is determined based on the thicknesses of the bump and the protrusion portion.

3. The liquid crystal display of claim 1, wherein the protrusion portion comprises an ovular or circular cross-sectional shape when viewed in a plan view.

4. The liquid crystal display of claim 1, wherein an edge portion of the shielding electrode portion partially overlaps the first electrode.

5. The liquid crystal display of claim 1, wherein a width of the bump is greater than a width of the data line by about one and a half times to about two times.

6. The liquid crystal display of claim 1, wherein the bump comprises an organic insulating material, a dielectric constant of the organic insulating material is equal to or smaller than about 3.2.

7. The liquid crystal display of claim 1, wherein the longitudinal extension of the common electrode portion is substantially parallel to the longitudinal extension of the data line.

8. The liquid crystal display of claim 1, wherein:
a slit is formed in the second electrode, the slit being disposed between the shielding electrode portion and the common electrode portion; and
a width of the slit is greater than a width of the common electrode portion.

9. The liquid crystal display of claim 8, wherein the first substrate further comprises:
a gate insulating layer disposed on the gate line and the first electrode; and
a protective layer disposed on the data line,
wherein the data line is disposed on the gate insulating layer, and
wherein the bump is disposed on the protective layer.

10. The liquid crystal display of claim 9, wherein the gate insulating layer and the protective layer comprise an opening portion formed therethrough and disposed in correspondence with the slit to expose the first electrode.

11. The liquid crystal display of claim 8, further comprising:
at least one protrusion bar, the first electrode being disposed directly on the at least one protrusion bar,
wherein the at least one protrusion bar protrudes toward the liquid crystal layer, and
wherein the longitudinal extension of the at least one protrusion bar is substantially parallel to the longitudinal extension of the data line.

12. The liquid crystal display of claim 11, wherein the at least one protrusion bar is disposed in correspondence with the slit.

13. The liquid crystal display of claim 11, wherein the common electrode portion is disposed on the at least one protrusion bar.

14. The liquid crystal display of claim 1, further comprising:
a protrusion bar disposed on the first base substrate,
wherein the common electrode portion is disposed directly on the protrusion bar,
wherein the protrusion bar protrudes towards the liquid crystal layer, and
wherein the longitudinal extension of the protrusion bar is substantially parallel to the longitudinal extension of the data line.

15. The liquid crystal display of claim 14, wherein a width of the protrusion bar is smaller than a width of the common electrode portion.

16. The liquid crystal display of claim 14, wherein a height of the protrusion bar is smaller than a height of the bump.

17. A method of manufacturing a liquid crystal display, comprising:
forming a first substrate, formation of the first substrate comprising:
forming, on a first base substrate, a gate line and a first electrode configured to receive a driving voltage,
forming a gate insulating layer on the gate line and the first electrode,
forming a data line on the gate insulating layer to cross the gate line,
forming a protective layer on the data line,
forming a bump on the protective layer along the data line, and
forming a second electrode comprising a shielding electrode portion disposed on the bump and a common electrode portion disposed in association with a center portion of the first electrode, the second electrode configured to receive a reference voltage;
forming a second substrate, formation of the second substrate comprising:
forming color filters on a second base substrate facing the first base substrate; and
forming a liquid crystal layer between the first substrate and the second substrate,
wherein adjacent color filters are formed to partially overlap one another in a region comprising the bump to provide a protrusion portion protruded from the second base substrate towards the first base substrate.

18. The method of claim 17, further comprising:
forming, in the second electrode, a slit between the shielding electrode portion and the common electrode; and
removing a portion of the protective layer and the gate insulating layer to form an opening portion disposed in correspondence with the slit.

19. The method of claim 17, further comprising:
forming a protrusion bar on the first base substrate, the protrusion bar protruding from the first base substrate towards the liquid crystal layer,
wherein the common electrode portion is disposed directly on the protrusion bar, and
wherein the longitudinal extension of the protrusion bar extends substantially parallel to the longitudinal extension of the data line.

20. The method of claim 17, further comprising:
forming, before the first electrode is formed, at least one protrusion bar, the at least one protrusion bar protruding from the first base substrate towards the liquid crystal layer,
wherein the first electrode is disposed directly on the at least one protrusion bar, and
wherein the longitudinal extension of the at least one protrusion bar is substantially parallel to the longitudinal extension of the data line.
